(19) United States
(12) Patent Application Publication
(10) Pub. No.: US 2015/0078028 A1
(43) Pub. Date: Mar. 19, 2015

(54) LAMP FOR VEHICLE

(71) Applicant: HYUNDAI MOBIS CO., LTD., Seoul (KR)

(72) Inventor: Myung Hun DO, Yongin (KR)

(21) Appl. No.: 14/477,128

(22) Filed: Sep. 4, 2014

(30) Foreign Application Priority Data
Sep. 16, 2013 (KR) 10-2013-0111151

(51) Int. Cl. F21S 8/10

(52) U.S. Cl. CPC F21S 48/1317; F21S 48/12; F21W 2101/10
USPC 362/516

(57) ABSTRACT

The present invention provides a vehicle lamp which is installed in a vehicle, including: a positioning lamp; and a bulb shade which reflects light radiating from the positioning lamp to be emitted onto an outer lens. Therefore, the light which is emitted by the positioning lamp is partially reflected by the bulb shade so that a light emitting area of the positioning lamp expands and the regulation for light distribution is satisfied while providing position discrimination to the other party. Therefore, a condition for an installation position of the positioning lamp is advantageously improved so that a degree of freedom of installation of the positioning lamp is increased.

### CROSS-REFERENCE TO RELATED APPLICATIONS

This application claims priority to and the benefit of Korean Patent Application No. 10-2003-0111151 filed in the Korean Intellectual Property Office on Sep. 16, 2013, the entire contents of which are incorporated herein by reference.

### TECHNICAL FIELD

The present invention relates to a lamp for a vehicle and more particularly, to a lamp for a vehicle which includes a bulb shade which reflects light irradiated from a positioning lamp so as to satisfy a regulation for light distribution.

### BACKGROUND ART

Generally, various types of vehicle lamps having various functions are provided in a vehicle. Among the vehicle lamps, a head lamp is provided in order to secure a clear view for a driver while driving at night.

The head lamp includes a light source, a reflector which reflects the light emitted from the light source to the front side, and a lens which refracts the light reflected from the reflector to the front side. Furthermore, the head lamp includes a shade which is provided between the reflector and an outer lens in order to implement a low beam to partially shield the light radiated from the light source.

Additionally, the head lamp includes a positioning bulb to widen a side illumination area so that improved perception is provided in the vehicle driving environment.

As a related art, Korean Registered Utility Model No. 20-0131537 discloses an expanded structure of an illumination area of a positioning bulb of a head lamp.

The expanded structure of an illumination area of a positioning bulb of a head lamp discloses, as illustrated in FIG. 1, a positioning bulb 5 which is provided at one side of a reflector 3 to which a bulb 2 is coupled.

Referring to FIGS. 1 to 3, the positioning bulb 5 will be described. Light which is turned on by the positioning bulb 5 is restricted by a reflector 3 and a shade 6 so that a spread range is concentrated to the front side and the light does not expand to the side of the outer lens 4 and is blocked.

Furthermore, the positioning bulb 5 is provided in a lower position than a bulb 2 such that an installation height is limited within a range which does not affect a light pathway of the bulb 2 whose light emitting direction is concentrated to the front side by setting the light pathway of the reflector 3.

That is, the installation position of the positioning bulb 5 is restricted so as to satisfy the regulation for light distribution.

Accordingly, as illustrated in FIG. 3, a light distribution reflective sheet 4a is further provided in the outer lens 4 in order to satisfy the regulation for light distribution, which may increase production cost.

Therefore, the light emitting area of a desired positioning bulb 5 needs to expand while adjusting a position of the positioning bulb 5 under a condition that there is no interference with the original function of the head lamp.

### SUMMARY OF INVENTION

The present invention has been made in an effort to provide a lamp for a vehicle which includes a bulb shade which partially reflects light emitted from a positioning bulb to increase a degree of freedom of installation of the positioning bulb and satisfy a regulation for light distribution.

The present invention provides a vehicle lamp which is installed in a vehicle, including: a positioning lamp; and a bulb shade which reflects light radiated from the positioning lamp to be emitted onto an outer lens.

One region of the bulb shade which is correspondingly formed to reflect the light emitted from the positioning lamp 100 has a curved shape so that light emitted from the positioning lamp has directivity toward the outer lens.

The light which is reflected through the bulb shade may be reflected onto an edge of the outer lens.

Here, the bulb shade may be plated with chrome.

The vehicle lamp according to the exemplary embodiment of the present invention with the above-mentioned configuration includes a bulb shade which partially reflects the light which is emitted from the positioning lamp to increase a degree of freedom of the installation of the positioning bulb and to satisfy a regulation for light distribution.

Further, the vehicle lamp distributes the light while satisfying the regulation for light distribution with the bulb shade so that there is no need to add a separate light distribution reflective sheet, which may result in a lighter weight and reduced cost.

Furthermore, positional restriction of the positioning bulb is reduced, which may result in the improvement of bulb convertibility and assemblability.

### BRIEF DESCRIPTION OF THE DRAWINGS

FIG. 1 is a view illustrating an expanded structure of a positioning bulb illumination area of the head lamp of the related art.

FIGS. 2 and 3 are views illustrating a positioning bulb which is provided in a vehicle lamp of the related art.

FIG. 4 is a view illustrating a vehicle lamp according to an exemplary embodiment of the present invention.

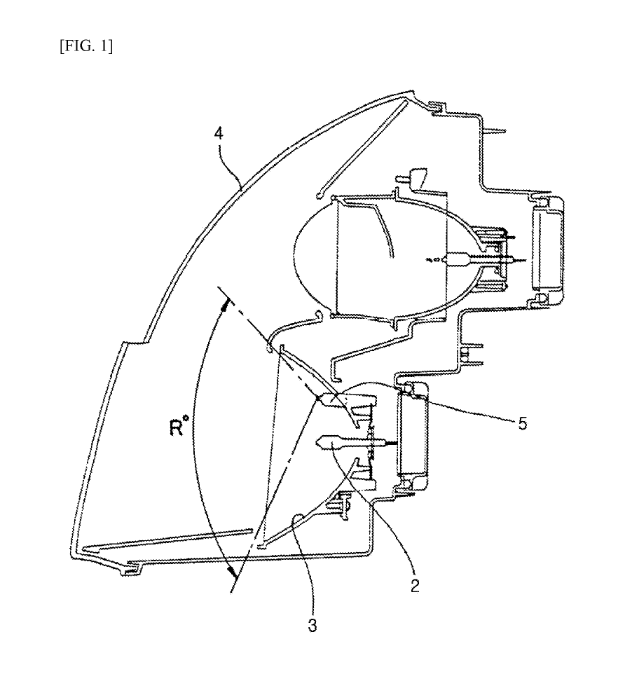

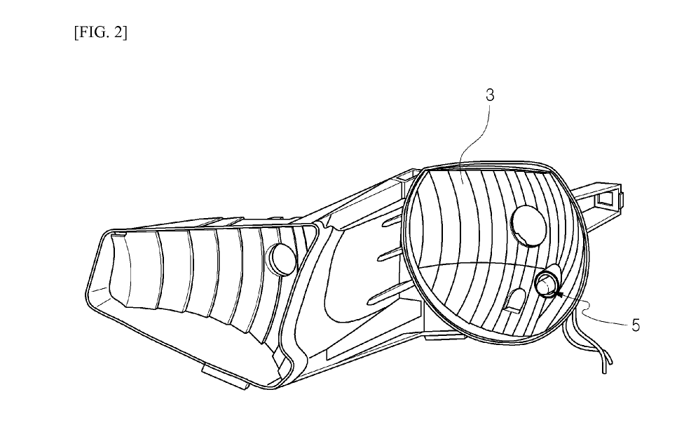

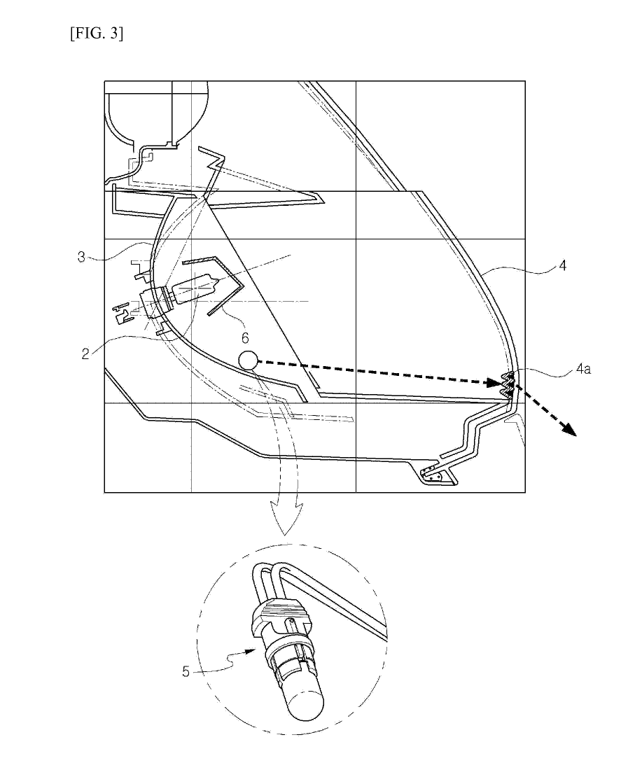

### DETAILED DESCRIPTION OF THE INVENTION

Hereinafter, exemplary embodiments of the present invention will be described in detail with reference to the accompanying drawings in order to clarify means for solving the technical problems of the present invention. However, when the description on a related technology obscures the gist of the present invention, the description thereof will be omitted. Furthermore, the terminology described below is defined in consideration of the function in the present invention and may vary depending on an intension of a designer or a manufacturer or a custom. Accordingly, the terminology needs to be defined base on details throughout this specification. Further, throughout the specification, like reference numerals denotes like components.

Hereinafter, a vehicle lamp according to an exemplary embodiment of the present invention will be described.

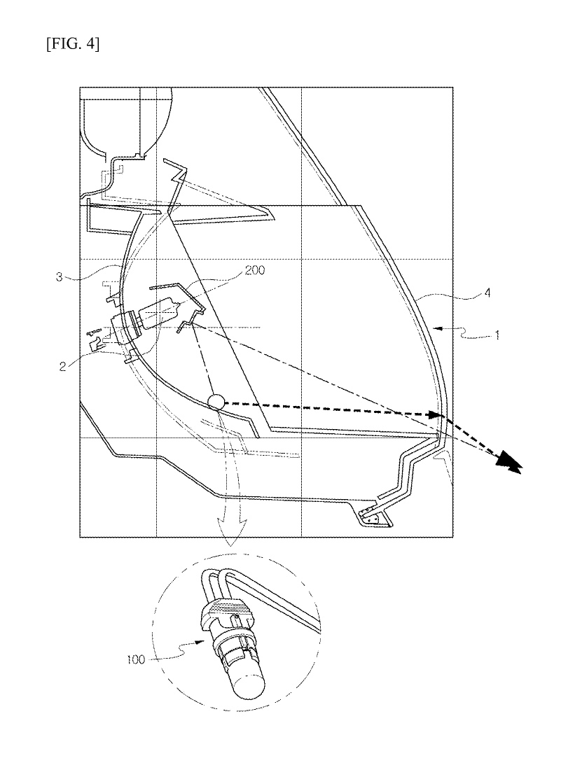

Referring to FIG. 4, a vehicle lamp 1 according to an exemplary embodiment of the present invention includes a bulb 2 which irradiates light, a reflector 3 which reflects light which is emitted from bulb 2, an outer lens 4 which refracts the light reflected by the reflector 3 to be radiated to the front of the vehicle, a positioning lamp 100 and a bulb shade 200 which are provided at one side of the reflector 3.

The positioning lens 100 is provided at one side of the reflector 3, as illustrated in FIG. 4, to expand a side illumination area as the lamp is turned on to provide an improved discrimination threshold.

Here, the positioning lamp 100 is desirably disposed in a position which does not interrupt the light that is emitted from the bulb 2.

The bulb shade 200 partially blocks the light radiated from the bulb 2 to form light which satisfies the regulation for light distribution.

Furthermore, the bulb shade 200 reflects the light radiated from the positioning lamp 100 to be emitted onto outer lens 4.

One region of the bulb shade 200 which causes the light radiated from the positioning lamp 100 to be emitted onto outer lens 4 has a curved shape so that light radiated from the positioning lamp 100 has directivity toward the outer lens.

That is, as illustrated in FIG. 4, one region of the bulb shade 200 which is correspondingly formed to reflect the light emitted from the positioning lamp 100 protrudes so that light radiated from the positioning lamp 100 has directivity toward the outer lens.

Accordingly, the light which is reflected through the bulb shade 200 is reflected onto an edge of the outer lens 4, as illustrated in FIG. 4. In FIG. 4, a dotted line represents light which is emitted from the positioning lens 100 to the outer lens 4 and a dash-dot line represents light which is emitted from the positioning lamp 100 and then reflected by one region of the bulb shade 200 to be reflected to the outer lens 4.

Therefore, the light which radiates from the positioning lens 100 of the vehicle lamp 1 is radiated onto the edge of the outer lens 4, as illustrated by the dotted line and the dash-dot line of FIG. 4, so that the light radiated from the positioning lens 100 may be evenly distributed. As a result, the regulation for light distribution may be satisfied without providing additional components.

In summary, a portion of the light radiated by the positioning lamp 100 is reflected by the bulb shade 200 so that a light emitting area of the positioning lamp 100 expands and the regulation for light distribution may be satisfied while providing position discrimination to the other party. Therefore, a condition for an installation position of the positioning lamp 100 is that the lamp position is advantageously improved so that a degree of freedom of installation of the positioning lamp is increased.

Here, the bulb shade 200 may be plated with chrome.

It is obvious that various exemplary-embodiments of the present invention may also solve technical problems other than the problems mentioned in this specification, not only in this technical field but also in related technical fields.

Until now, the present invention has been described with reference to the exemplary embodiment of the present invention. The above description illustrates a technical spirit of the present invention as an example and various changes, modifications, and substitutions become apparent to those skilled in the art within a scope of an essential characteristic of the present invention. Therefore, as is evident from the foregoing description, the exemplary embodiments and accompanying drawings disclosed in the present invention do not limit the technical spirit of the present invention and the scope of the technical spirit is not limited by the exemplary embodiments and accompanying drawings. The protection scope of the present invention should be interpreted based on the following appended claims and it should be appreciated that all technical spirits included within a range equivalent thereto are included in the scope of the present invention.

What is claimed is:

1. A vehicle lamp which is installed in a vehicle, comprising:
a positioning lamp; and
a bulb shade which reflects light radiating from the positioning lamp to be emitted to an outer lens.

2. The vehicle lamp according to claim 1, wherein one region of the bulb shade which is correspondingly formed to reflect the light radiating from the positioning lamp 100 has a curved shape so that light radiating from the positioning lamp has directivity toward the outer lens.

3. The vehicle lamp according to claim 2, wherein the light which is reflected through the bulb shade is emitted onto an edge of the outer lens.

4. The vehicle lamp according to claim 1, wherein the bulb shade is plated with chrome.
